(19) United States
(12) Patent Application Publication
(10) Pub. No.: US 2003/0019321 A1
(43) Pub. Date: Jan. 30, 2003

(54) Cam device for climbing

(76) Inventors: Mikel Apezetxea, Hernani (ES); Inaki Xabier Zabala, Hernani (ES)

Correspondence Address: BROWDY AND NEIMARK, P.L.L.C., 624 NINTH STREET, NW, SUITE 300, WASHINGTON, DC, 20001-5303, US

(21) Appl. No.: 10/183,986

(22) Filed: Jun. 28, 2002

(30) Foreign Application Priority Data
Jun. 28, 2001 (ES) P200101577

(51) Int. Cl. F16H 53/00

(52) U.S. Cl. 74/567

(57) ABSTRACT

This invention concerns a device, which, when used in climbing, acts as an anchor in cracks with two parallel sides. The device consists of several opposing cams that rotate on the same shaft. The force generated when a climber falls is counteracted by the force of the friction between the cams and the rock. As opposed to other known spring-operated devices, the load generated by a fall acts directly on the cams (2, 3), and not on the shaft (1), through cables (6) that pull on the cams on the side of the shaft opposite the edge that is in contact with the wall, and which are supported on convex surfaces formed by the cams themselves.

This invention concerns a device, which, when used in climbing, acts as an anchor in cracks with parallel sides. There are currently a number of devices known as ‘spring-operated cam devices’ that use a cam system to perform a similar function.

### BACKGROUND TO THE INVENTION

U.S. Pat. No. 4,184,657 describes how spring-operated cam devices operate by converting a traction force moving out of the crack into a force moving in against the faces through the use of cams. The friction created between the cams and the crack counteracts the force pulling on the device.

In general these devices consist of four cams mounted on a single shaft on which they can rotate and which is pulled on by a rod. The four cams are exactly the same but the two cams located at the ends of the shaft point out to one side whereas the other two point out to the other side.

The edge of the cams that make contact with the wall forms a log spiral, the pole of which lies in the shaft. The radius of the log spiral increases gradually between two measurements, in accordance with the range of the spiral. The device can thus be used in cracks formed between two limits that determine the degree to which the device can be expanded. The edge of the cam must form a log spiral so that the limit coefficient of friction that enables the device to secure itself is the same in the cracks of different widths into which it is inserted. The device can be expanded by increasing the range of the spiral but this also increases the limit coefficient of friction by which the device operates, thus reducing the device's ability to secure itself.

Springs are used to extend the cams fully. The device is inserted into a crack by pulling on a trigger attached to cables that gather together the cams, with the end of the rod acting as the support point. The device is then inserted into the crack and the trigger is released. All the cams are then forced by the springs and secure themselves in position on the sides of the crack.

Patent AT-B-398.167 B describes a system wherein the load that the device has to support is applied by cables. This load is exerted not on the shaft but directly on the cams on the side of the shaft opposite the edge that makes contact with the wall. As a result, if the cable is pulled the cam tends to rotate towards a position in which it is extended further. The cables pull straight on each cam and as the cams can adopt different rotational positions, each cable is connected to each cam by a metal link.

The momentum of the shaft exerted on the cam when force is applied at a distance from the shaft and not directly on it can increase the range of the spiral or, if the range remains the same, can increase the device's ability to secure itself. However, in the different rotational positions of the cams, the distances from the shaft to the side of the crack and to the vector of the force applied by the cable do not remain proportional to each other. This means that the device's ability to secure itself varies according to the different rotational positions of the cams. As for the distribution of the loads on the cams, although the loads can be distributed evenly on the cams pointing to one side and the cams pointing to the other, it is not possible to distribute the loads evenly on the two cams on one side when these are in different rotational positions. Furthermore, as the body of the device is formed by the cables that pull on the cams, these cables must be sufficiently rigid in order to take the load off the device.

It is an object of this invention to provide a cam device especially for use in climbing and which functions equally well in all the possible rotational positions of the cams.

Another object of this invention is to create a cam device wherein the force exerted on the device is distributed evenly between the cams, even when they are all in different rotational positions.

### DESCRIPTION OF THE INVENTION

In order to achieve these objectives, the device that is the object of this invention consists of a number of opposing cams that can rotate on the same shaft. Cables attached to the cams apply the load that the device has to withstand. The main innovation of the device is the way in which the cable acts on the cam.

Each end of the cable, which should be as flexible as possible, is secured to a cam and exerts the load on it on the side of the shaft opposite the edge that makes contact with the wall, supported on a convex surface formed by the body of the cam itself or by a component attached to it.

To ensure that all the possible rotational positions of the cams function equally well, the convex surface where the cables are supported form a log spiral with a range and pole equal to the one formed at the edge of the cam that is in contact with the wall. This spiral unwinds in the same direction as the other spiral.

As part of this system, in each cam the distances from the shaft to the side of the crack and to the vector of the force exerted on the cable, irrespective of the rotational position of the cams, are, ideally, proportional to each other.

The end of a component that applies the load on the cams is attached to each cam in each pair of opposing cams and by pulling on the middle section of this component the pair of cams is also pulled. In a device with two pairs of cams the two cables are pulled by a unit consisting of two slings with terminals and with two eyelets or grommets on either end, linked together by a belt. One of the cables that pulls on the cams is passed through each terminal on the free ends of the slings, which are connected by a rigid unit called a distributor. By pulling on the belt the force applied on the device is distributed evenly between the four cams even when one of them is in a different rotational position. The distributor tilts when the two opposing cams are in a more extended rotational position than the other two cams.

The body of the device consists of a flexible rod connected to the shaft at its midpoint. The rod, together with a trigger connected to each of the cams forms a unit in which the cams are retracted when the device is removed from or inserted into a crack.

The cams are rotated to a position in which they are fully extended by a spring that exerts pressure on the cables applying the load on the cables. This spring, which is crossed through and guided by the rod at the same time, acts when the shaft and distributor are compressed. When the trigger is pulled the slings and distributor are moved, pulled towards the shaft by the cables pulling on the cams, thus compressing the spring. The spring acts on a catch on the distributor. When the distributor tilts the catch turns and is held on the same plane, ensuring that the spring continues to operate effectively.

### A BRIEF DESCRIPTION OF THE DIAGRAMS

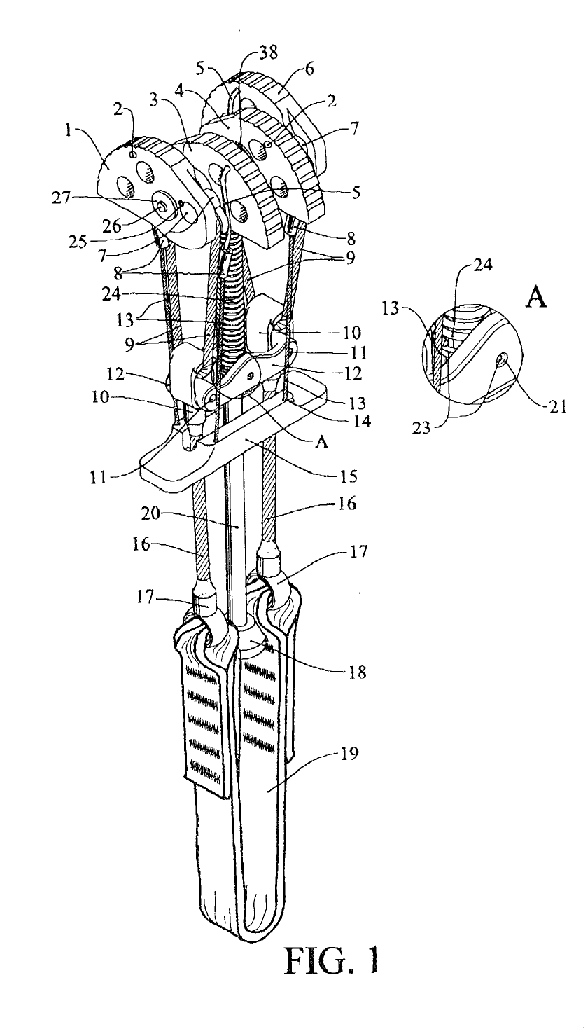

FIG. 1 is a diagram of the device with the cams in a fully extended position.

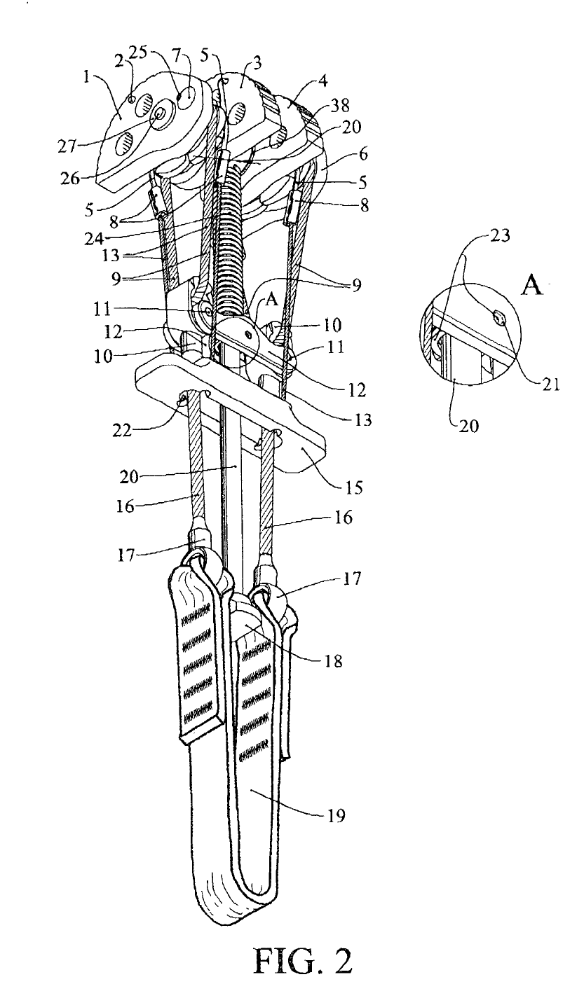

FIG. 2 is a diagram of the device with the cams in a fully extended position.

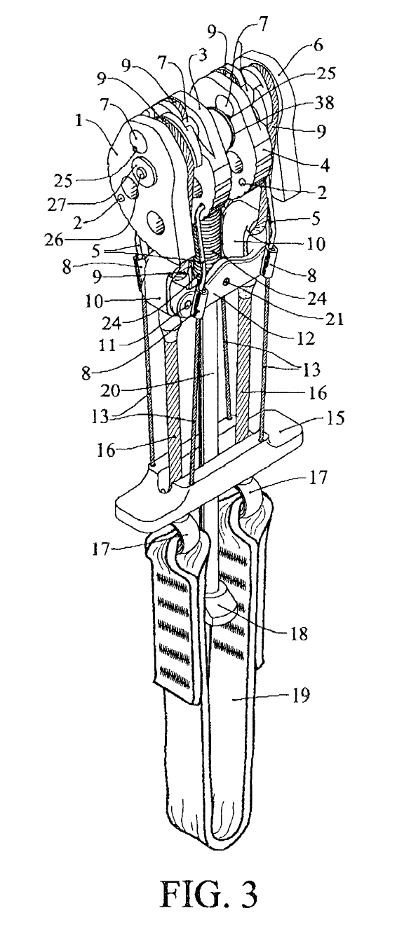

FIG. 3 is a diagram of the device with the cams in a fully retracted position.

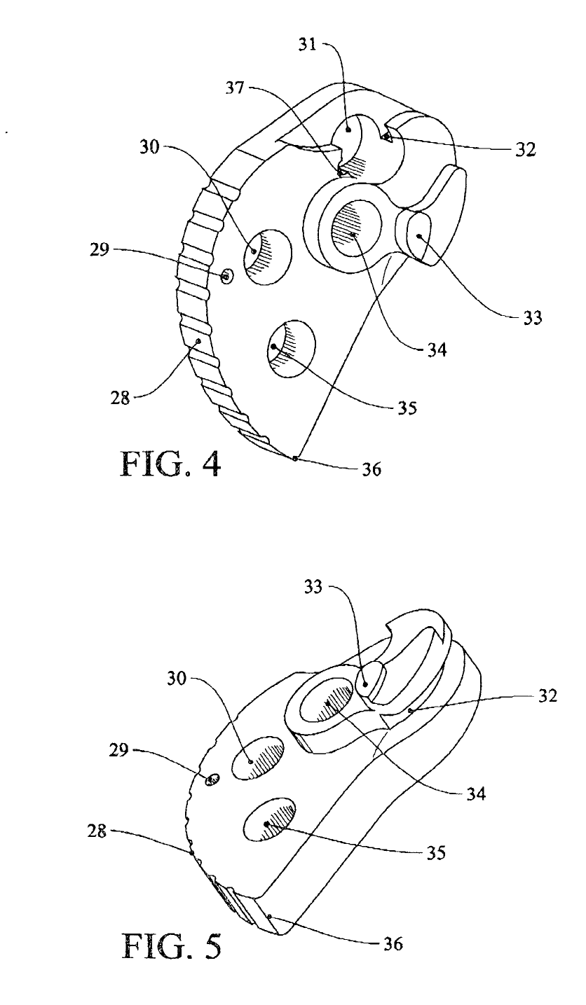

FIG. 4 is a diagram of one of the cams of the device.

FIG. 5 is a diagram of one of the cams of the device.

### DESCRIPTION OF A PREFERRED METHOD OF MAKING THE DEVICE

FIGS. 4 and 5 are both diagrams of a cam, e.g., one of the cams (1, 3, 4, 6) in FIGS. 1, 2, and 3. These diagrams show the spiral that forms the edge (28) that is in contact with the wall and the spiral that forms the interior surface (32) of the groove in which the cable is supported when it pulls on the cam. The shaft (26) on which the cam rotates is introduced in the hole (34). The function of the other holes, (30) and (35), is to reduce the weight. The catch (33) prevents the cams from rotating beyond the position in which they are fully extended. As can be seen in FIGS. 1, 2 and 3 the cams (1) and (3) are the same and cams (4) and (6) are symmetrical to them.

The cables (9) are as flexible as possible. Cylindrical terminals with a groove (7) have been injected onto the ends of the cables. In order to secure the cable to the cam the terminal is fitted into the hole (31) in the cam and is then rotated until the cable rests on the interior surface (32) of the groove. To immobilise the terminal a plastic fastener (25) is then inserted into the recess formed between the groove on the terminal and the groove on the cam (37). This prevents the terminal from working loose from the cam. Before the two terminals (7) are secured on the two cams in an opposing pair of cams, one of the terminals must be fed through the terminal (10) on the slings that pull on the cables (9).

These slings are made with cables that are as flexible as possible (16) and welded or pressed terminals (10, 17). The terminal (10) through which the cable (9) passes must have a eyelet that is large enough and shaped in such a way that the cable (9) terminal (7) can be inserted into it and the distributor unit housed in it, with the distributor having enough space to tilt. Furthermore, the area where the cable (9) and the terminal (10) come into contact with each other should be sufficiently curved so that the cable is not damaged. The lower terminal (17) must have a eyelet that is large enough to allow the belt (19) to be inserted into it and must not have rough edges as these may damage the belt. The ends of the belt are sewn together (19) once it has been fed through the respective terminals (17).

The distributor unit is made up of two metal parts (12), which, once they have been fitted into the terminals (10), one on either side, are riveted together (11). The length of the distributor establishes the gap separating the terminals (10) which, along with the gap between the two pairs of cams, must be wide enough to ensure, first of all, that the cables (9) do not touch the edges (36) of the cams when the cams are retracted fully and that the distributor tilts sufficiently, between 45° and 60° approximately, when one of the pairs of cams is fully retracted and the other pair is fully extended. The parts (12) each have holes (21) in their mid sections. These act as supports for the catch (23) on the spring (24). The spring is mounted in the inner section of the parts (12) and can rotate around them. This catch (23) is crossed through by the rod (20) and acts as a stop for the spring (24). The catch must be fitted into position at the same time as the metal parts (12) are inserted into the terminals (10) so that it cannot work loose once they have been riveted.

The rod (20) is made of a light, elastic material and is capable of withstanding, without bending, the force of compression that acts on it when the trigger (15) is pulled. The support point (18) is a separate piece that is stuck with adhesive to the rod after the rod has been inserted into the spring (24) and the catch (23).

A trigger (15), with a large enough space inside it to allow both the rod (20) and, when the unit is being assembled, the lower terminals (17) to pass through, is used to retract the cams (1, 3, 4, 6). The trigger (15) is connected to each of the cams by cables (13) and auxiliary wires (5) so that when the trigger is pulled a force is exerted on the cams on the same side of the shaft (26) as the edge (25) that is in contact with the wall. The cables (13) are fastened to the trigger (15) by pressing a terminal (22) on one end after the cable has been introduced through the hole in the trigger (14). The cables (13) are connected to the auxiliary wires (5) with pressed copper sleeves (8) and the auxiliary wires (5) are attached to the cams by bending them to form heads at the tips (2) after they have been inserted into the holes (29) in the cams.

The opposing pairs of cams formed by pairs (1) and (3) and (4) and (6) are mounted on the shaft as well as the rod (20) which is positioned between cams (3) and (4) and is separated from them by internal washers (28). Once the unit has been assembled, a washer (27) is positioned on both ends of the shaft (26), both of which have been machined with a smaller diameter than the rest. The end of the shaft is then riveted over the washer.

1. A cam device for climbing of the type that offers protection in cracks with two facing sides, with opposing cams that rotate on the same shaft and on which the load is directly applied on the side of the shaft opposite the edge that is in contact with the wall and which has the following features:
on at least one of the cams the component that applies the load on the cam does so when it is supported on a convex surface formed by the cam itself or by a component connected to it.
one end of the component that applies the load to the cams is fastened to each cam in each pair of opposing cams so that when this component is pulled the pair of cams is also pulled.
the cams are rotated to the position in which they are fully extended by a spring that exerts pressure on the components applying the load on the cams.

2. A cam device for climbing according to claim 1 wherein the convex surface supporting the component applying the load on the cam forms a log spiral with the same range and pole as the one forming the edge of the cam in contact with the wall, with both spirals unwinding in a clockwise direction.

3. A cam device for climbing according to claim 1 wherein the component applying the load to each pair of cams is a steel cable.

4. A cam device for climbing according to claim 1 wherein the component applying the load on each pair of cams is pulled by a sling with terminals that have eyelets on either end.

5. A cam device for climbing according to claim 4 wherein the terminals on the slings through which the components that apply the load to the cams pass are connected by a rigid unit.

6. A cam device for climbing according to claim 5 wherein a spring acts when the rigid unit and the shaft are compressed, being crossed through and guided at the same time by the rod.
